(19) United States
(12) Patent Application Publication
(10) Pub. No.: US 2011/0022519 A1
(43) Pub. Date: Jan. 27, 2011

(54) SYSTEM AND METHOD OF ADVERTISING MESSAGE DISTRIBUTION BY EMPLOYING PORTABLE MEDIA PLAYER

(76) Inventor: Yang Pan, Shanghai (CN)

Correspondence Address: Yang Pan;Intellectual Power Pte Ltd, No. 14 Robinson Road #06-01,, Far East Finance Building, Singapore, 048545, SG

(21) Appl. No.: 12/506,296

(22) Filed: Jul. 21, 2009

(51) Int. Cl. G06Q 30/00; H04L 9/30

(52) U.S. Cl. 705/51; 705/14.73; 705/14.64; 705/14.66; 705/14.65; 705/14.42

(57) ABSTRACT

System and method is disclosed for distributing advertising messages by employing a portable media player. Selected media assets and advertising messages are pre-loaded to the media player based upon a targeted user's personal profile which indicates the user's personal interests in specific media asset groups and in specific advertising message groups. The operation of “pre-loading” may be performed at a manufacturing site or at a point of sales. The selected media assets may be encoded. At least one advertising message is delivered to the user through an output unit of the media player before a selected media asset is decoded and is delivered. The storage capacity of a storage unit of the device is managed by a software module. Each pre-loaded media asset and advertising message is assigned a priority in a sequential manner. The lower priority assets and messages are deleted, in a manner un-notified to the user, when the storage capacity is required as a result of the user's operation of the device. The priority of the delivered advertising message may be adjusted and advertising messages and media assets may be replaced by new ones when the device is connected to a server.

### CROSS-REFERENCE TO RELATED APPLICATIONS

This application is related to:

U.S. patent application Ser. No. 12,175,455 entitled “Hierarchical categorization of media assets and user interface for media player” submitted on Jul. 18, 2008 by Yang Pan;

U.S. patent application Ser. No. 12,202,228 entitled “Methods for rendering recommended media assets to a user by employing a handheld media player” submitted on Aug. 30, 2008 by Yang Pan; and

U.S. patent application Ser. No. 12,496,486 entitled “Methods of media asset distribution by employing electronic apparatus” submitted on Jul. 1, 2009 by Yang Pan.

### BACKGROUND

1. Field of Invention

This invention relates generally to advertising message distribution. More specifically, the invention describes methods for distributing advertising messages by employing portable media players.

2. Description of Prior Art

It has recently become popular to deliver media assets to a user by employing portable media players. The assets can be transferred from a server in the Internet to a portable media player connecting to a personal computer. A portable media player stores media assets, which can be played on the device. Examples of portable media players are the iPod from Apple Inc. of Cupertino, Calif., the Zen from Creative Technology Ltd, Singapore and the Zune from Microsoft Inc of Redmond, Wash. The portable media players have gained popularity because of its capability to store large number of media assets. The device can be put into a user's pocket when one travels. The portable media players have also been integrated with other portable devices such as mobile communication devices. An example of the successful implementation is the iPhone from Apple.

Portable communication devices such as mobile phones have been used extensively to distribute advertising messages. U.S. Pat. Nos. 5,913,040, 6,317,789, 6,539,429 to Rakavy et al disclosed prior arts to utilize an idle screen of a mobile device to display advertisement messages, which are delivered to the user's device without user's notification. The messages are displayed preferably as a screen saver. U.S. Pat. No. 6,363,419 to Martin, Jr. et al and U.S. Pat. No. 7,369,864 to Vaananen disclosed methods to display useful or commercial information on an idle screen. US patent application 2004/0077340 by Forsyth and the application 2006/0156256 by Lee disclosed similar ways to use idle screen for displaying commercial information with the user's programmability on the displayed contents.

The mobile communication device integrated with a position identification function can be used to provide location specific information to users of such devices. Position determination on mobile communication device can be accomplished through the use of Global Positioning System (GPS) satellites.

One application which uses location specific information of the mobile communication devices is advertising. It has been recognized that in order to maximize the return of on any particular advertisement, advertisers desire to provide their advertisements to a demographic which is most likely to be interested in the particular advertisement. Accordingly, by providing the advertisement based upon location specific information, an advertiser's financial resource need not be wasted on advertisement provided to people who are not currently in the vicinity of the advertiser.

Interactive advertising by use of mobile communication devices provides opportunities for advertisers to target their advertisements to a receptive audience. That is, targeted advertisements are more likely to be useful to end users since the advertisements may be relevant to a need inferred from some user activity. Presently, the capability to push information to a mobile communication device from a networked based system through the wireless communication infrastructure exists. A number of U.S. patents and patent applications have been published for various prior arts for location based advertisement by use of mobile communication devices. They include U.S. Pat. No. 6,650,902 to Richton, U.S. Pat. No. 6,813,501 to Kinnunen at al, U.S. Pat. No. 6,452,498 to Stewart, U.S. Pat. No. 6,505,046 to Baker, US patent application 2006/0253481 by Guido et al, US patent application 2002/0026361 by Blom and US patent application 2007/0149212 by Gupta et al. All the listed prior arts propose methods to deliver the advertisements to a user associated with a mobile communication device when the user's position is identified.

There have been portable electronic devices used by many users, which may not have the functionality of connecting directly to a communication network. An example of the device is iPod from Apple. With the increasing in semiconductor memory density driven by the Moore's law, portable media players will have higher and higher storage capacity available. Very often, a large portion of the storage capacity is not fully utilized. The use of such as an idle storage capacity to distribute media assets from a merchandiser to a user has been proposed by the present inventor in the previous patent application Ser. Nos. 12,175,455, 12,202,228 and 12,496,486. The idled storage capacity may also be explored to distribute advertising messages. Thus a portable media player without a direct communication means may also be utilized to deliver advertising messages. The user may exchange the rights for playing a pre-loaded media asset by listening/viewing an advertisement clip.

Accordingly, it is an object of the present invention to provide system and method of distributing advertising messages to a user by employing portable media player even when the device has not possess direct communication capability to a communication network.

It is another object of the present invention to provide methods for distributing advertising messages based upon a user's personal profile indicating the user's interests in specific advertising message groups. The messages can therefore be distributed to a targeted user effectively.

It is yet another object of the present invention to provide methods for distributing advertising messages to the user by utilizing idling storage capacity. The selected media assets and advertising messages are pre-loaded to the storage unit of the portable media player. Each pre-loaded data file (media asset and advertising message) is assigned a priority. Lower priority data files are removed automatically in an un-noticed manner to the user when the storage capacity is required as a result of the user's operation of the device.

### SUMMARY OF THE INVENTION

The invention described herein pertains to system and method of distributing media assets and advertising messages. The invention is characterized by that media assets and advertising messages are pre-loaded to a portable media player before it is shipped to the user.

According to one embodiment, the user may select a pre-loaded media asset for playing through an input unit of the media player. An advertising message is then selected and streamed to an output unit of the media player before the selected asset is delivered. The media assets may be encoded based upon the public key/private key system before they are loaded to the device. A private key for decoding the selected media asset is released after the advertising message is played.

According to one aspect of the present invention, the advertising message is selected from the pre-loaded ones for delivering in a random manner. According to another aspect of the present invention, each pre-loaded advertising message is assigned a priority. After the user selects a media asset for playing, the advertising message is selected based upon its priority. The advertising message with the highest priority is selected. The media asset is played after the highest priority advertising message is streamed to the output unit of the device. The priority of advertising message may be adjusted after the message is delivered.

According to another embodiment of the present invention, each pre-loaded data file (media asset and advertising message) is assigned a priority. They are pre-loaded to the storage unit of the portable media player. The storage capacity for the pre-loaded data files is managed by a software module. The lower priority data files are removed automatically when at least a portion of the storage capacity is required as a result of the user's operation of the device.

According to yet another aspect of the present invention, the delivered advertising messages and media assets may be replaced by new ones when the media payer is connected to a server such as a personal computer.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of functional blocks of a portable media player,

FIG. 2 is a schematic diagram of the media asset and advertising message distribution system,

FIG. 3A is a flow diagram of depicting steps for distributing media assets and advertising messages by the use of a portable media player, wherein the media assets and advertising messages are selected and loaded up to the media player before it is shipped to the user,

FIG. 3B is a flow diagram of depicting steps for distributing media assets and advertising messages by the use of a portable media player, wherein steps for encoding/decoding the media assets are shown,

FIG. 4A is a schematic diagram of a file format for storing filed data and file attributes with added fields for the “visibility” and the “priority” for a media asset and advertising messages,

FIG. 4B is a schematic diagram illustrating exemplarily a priority ranking system for pre-loaded media assets and advertising messages,

FIG. 5 is a schematic diagram of depicting steps for managing storage capacity of the portable media player based upon the priority of media assets and advertising messages,

FIG. 6 is a flow diagram of depicting steps for distributing media assets and advertising messages by the use of a portable media player and each media asset and each advertising message is assigned a priority,

FIG. 7A is a schematic diagram of a file format for storing filed data and file attributes with another added fields for the “replacement” of the file when the portable media player is connected to a server,

FIG. 7B is a flow diagram of depicting steps for replacing advertising messages and/or media assets when the portable media player is hooked up with a server.

### DETAILED DESCRIPTION

References will now be made in details to a few embodiments of the invention, examples of which are illustrated in the accompanying drawings. While the invention will be described in conjunction with the particular embodiments, it will be understood that it is not intended to limit the invention to the described embodiments. To the contrary, it is intended to cover alternatives, modifications, and equivalents as may be included within the spirit and scope of invention as defined by the appended claims.

In various embodiments of the invention, the term “advertising messages” may include text, graphics, video, audio and multimedia messages. It should be appreciated that while advertising messages are used herein as exemplary embodiments of the invention, any document may be used in accordance with the various embodiments. For instance, documents such as advertisements, content pages, search results, emails, IM messages, audio content or files, video contents or files, other data or applications that may reside on one or several of computing systems, or other definable concepts or content may be used. Thus although the use of advertising messages are described herein as examples, other documents such as web pages may be targeted to viewers and displayed in accordance the various embodiments, e.g. as described herein with respect to advertising messages.

It should be understood that an advertising message as used herein may comprise audio and/or video signals, static and/or dynamic images, graphics, video, film, or other content that relate to one or more products, services, and/or entities, such as commercial entities. Advertising messages may also comprise various visual features, including animation, sound etc., and may include text, such as in a text advertisement. Thus, the term “advertising messages” is used herein in its broadest sense to include any content or object intended for observation, use, or consumption by one or more persons for the purpose of marketing or promoting a product or service. While, advertising messages are used for exemplary purpose, it should be understood that any audio and/or video content, such as television programming, may be used with the systems and methods described herein.

The term “media asset” as used herein generally refers to media files with an associated intellectual property right. Examples of media asset include a media file for audio, video, text, graphics and multi-media content. A user needs to purchase the right for playing the content in a media delivery unit such as for example, in a portable media player. In the present invention, the user exchanges the right for playing a media asset by listening/viewing an advertising message.

The term “media player” as used herein generally refers to computing devices that are employed to processing media files such as audio and video assets. In one implementation, the media player is a portable computing device. Examples of media players include music players, game players, video players, electronic books, video recorders, cameras, and the likes. These media players are generally portable so as to allow a user to listen to music, play games or video, read text, record video or take pictures wherever the user travels. The media player is a portable device that is sized for placement into a pocket of the user. By being pocket sized, the user does not have to directly carry the device and therefore the device can be taken almost anywhere the user travels.

The media player typically has connection capabilities that allow a user to upload and download data to and from a host device such as a general purpose computer. With regard to music player, songs and playlists stored on the general purpose computer may be downloaded into the music player. In the present disclosure of the invention, a music player with a video display capability is taken as an exemplary case for the purpose of the illustration but not limit the scope of the invention.

The basic operation of a media player (music player) is described as follows. A portable media player comprises a processor and a file storage unit that is typically a flash memory or a plurality of flash memories. It further comprises a user input unit such as a rotational user input device used in some iPod's from Apple and a user output unit such as a Liquid Crystal Display (LCD) screen. In a touch-screen approach, the display screen may also be used as a portion of the input unit. The storage unit stores data files such as media assets. A user selects a media asset from a user interface. The processor receives the selection and controls the operation of sending the selected media asset to coder/decoder (CODEC) for the signal processing to generate analog signal for further delivering to speakers and to the LCD screen for an audio/video experience. The media player has a data link for connecting to a computer. A battery, more particularly, a rechargeable battery is used to provide power for the player.

Since the display screen associated with a portable media player is typically small, an efficient user interface is required to allow a user intuitively navigate among, and select, media assets to be played. The operation typically includes an overlapping hierarchy of categories. Categories include items that can also be included in other categories so that the categories overlap with each other. Thus, a media asset title can be accessed in multiple different ways by starting with different categories. For example, the top-level categories “Album”, “Artists”, “Genres” and “Playlists” are presented to a user first. Within the Albums category are names of different albums of media assets stored in the device. Within each album are album tracks, or assets, associated with that album. Similarly, the Artists category includes names of artists which are, in turn, associated with their albums and assets. The Genre category includes types of categories of music such as “Rock”, “Classical”, “Pop”, etc. Within these sub-categories are found associated assets. Finally, the “Playlists” category includes collections of albums and/or assets which are typically defined by the user.

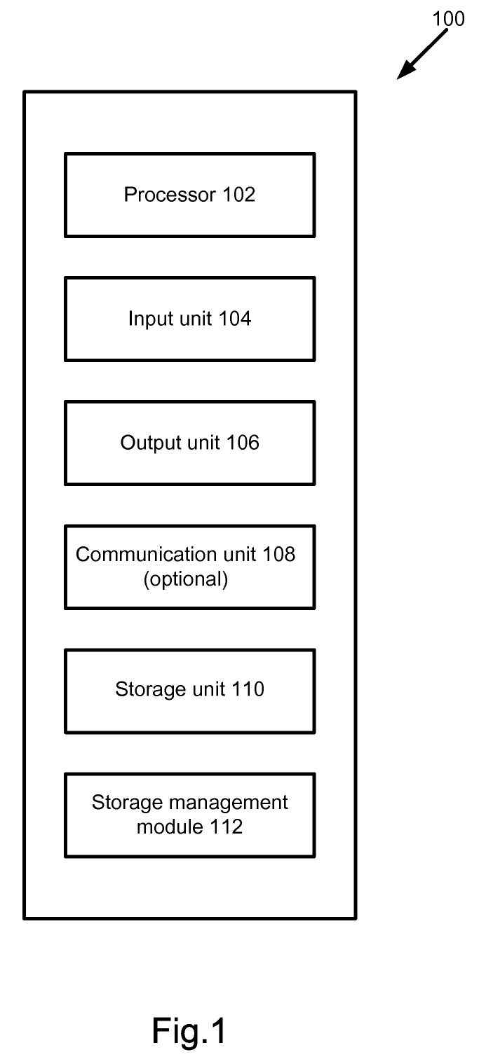

FIG. 1 is a schematic diagram of the functional blocks of a media player 100. The media player 100 may comprise a processor 102 pertaining to control operations of the device, an input unit 104 and an output unit 106. The input unit 104 may comprise a rotational user input device, keys and touch pads. The output unit 106 may comprise a Liquid Crystal Display (LCD) screen. The exemplary media player 100 may further comprise a communication unit 108 as an optional functional block. It should be noted that the media player disclosed in the present invention does not require the communication unit 108 to be functional. The communication unit 108 may be a wireless transceiver conforming to various IEEE standards and their amendments such as IEEE 802.11 (WLAN), IEEE 802.15.1 (Bluetooth) and IEEE 802.15.4 (ZigBee). The media player 100 may also include a file storage unit 110. The file storage unit 110 is typically a semiconductor flash memory device or a plurality of flash memory devices or a magnetic storage device such as a hard disk driver. The file storage unit 110 may also include a cache to improve the data access time. The file storage unit 110 is managed by storage management module (software) 112 through the processor 102. The media player 100 is powered by a battery or more specifically a re-chargeable battery (not shown in the figure).

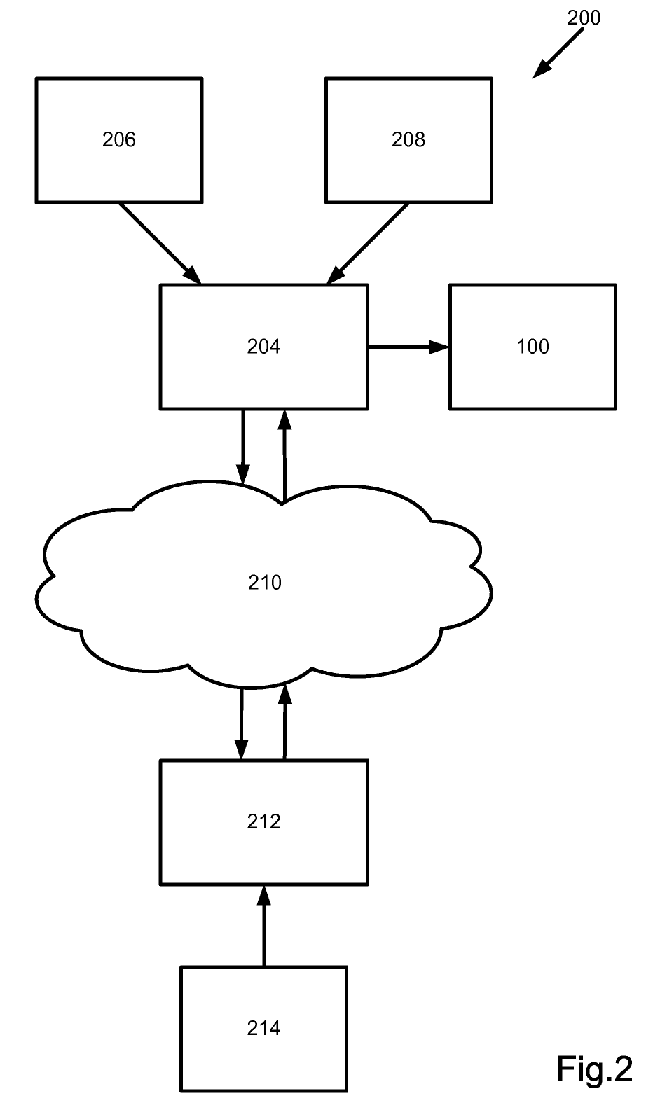

FIG. 2 is a schematic diagram of depicting of a media asset and advertising message distribution system 200. A media player 100 is connected to a server 204 before it is shipped to the user. An advertiser 206 and a media asset distributor 208 are connected to the server 204. The advertiser 206 and the media asset distributor 208 may be the same merchandiser in some instances. The server 204 is connected to a communication network 210. The communication network 210 is the Internet in an exemplary illustration of the invention. Another server 212 operated by the user 214 is also connected to the communication network 210. The server 204 is typically located at a manufacturing site or at a point of sales. According to one implementation of the invention, the user 214 sends his or her personal profile file to the server 204 through the server 212. The personal profile file includes data indicating the user's interests in specific media asset groups and in specific advertising message groups. According to another implementation of the present invention, the user may upload his or her personal profile file into the server 204 directly at a point of sales. The advertiser 206 and the media asset distributor 208 select a group of advertising messages and a group of media assets based upon the user's personal profile and download the data files into the media player 100. The media player 100 will have pre-loaded media assets and advertising messages before it is shipped to the user.

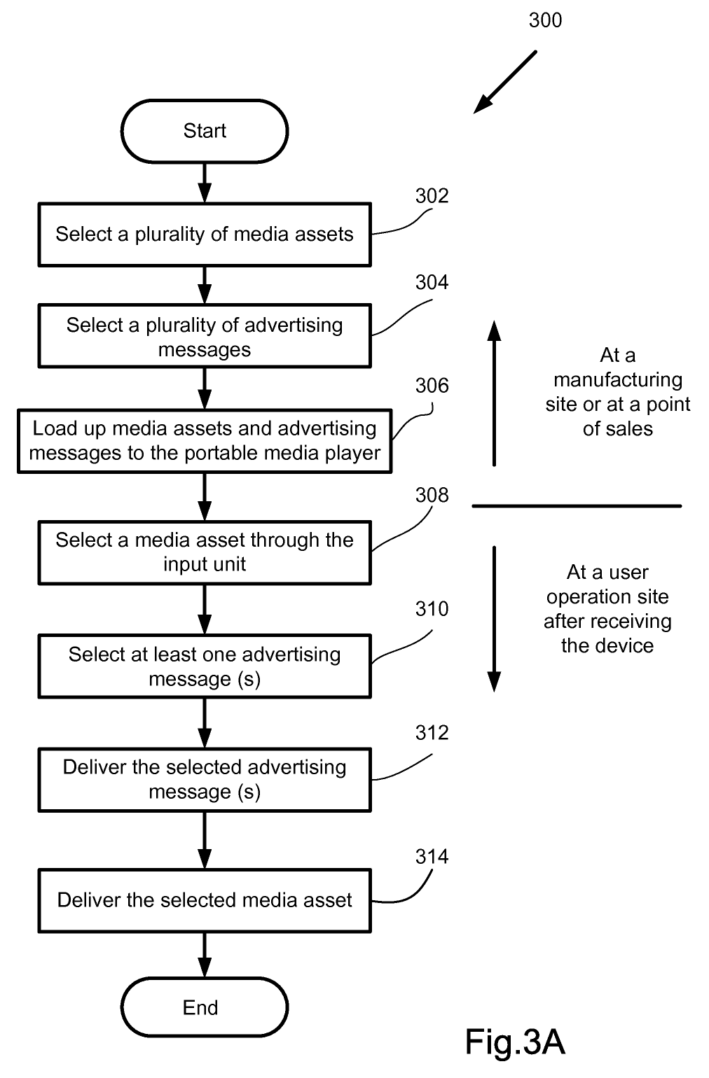

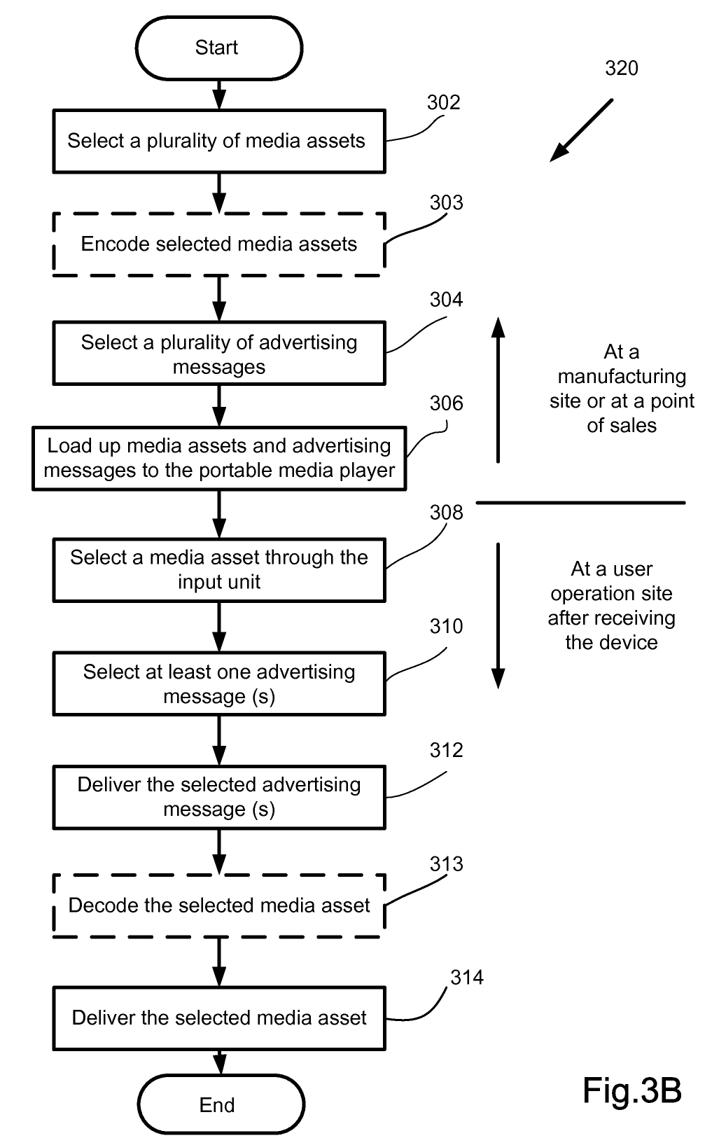

FIG. 3A is a flow diagram of depicting steps for distributing media assets and advertising messages by the use of a portable media player. The process 300 starts with steps 302 and 304 that a plurality of media assets and a plurality of advertising messages are selected based upon a targeted user's personal profile. In step 306, the media assets and advertising messages are loaded up to the media player. The operations may be performed at a manufacturing site or at a point of sales. After receiving the media player, the user selects a pre-loaded media asset through the input unit 104 in step 308. Following the step 308, the processor 102 of the media player 100 selects at least one pre-loaded advertising message in step 3 10. The processor 102 controls an operation of streaming the selected advertising message(s) to the output unit of the media player 100 in step 312. The selected media asset is then delivered to the user in step 314. It should be noted that there are various ways of implementation within the spirit and scope of the invention based upon the embodiment described in FIG. 3. For example, more than one advertising message may be selected in the step 310 and be delivered in the step 3 12. Moreover, the selected advertising message (s) may be delivered more than one time. Furthermore, more than one media asset may be allowed to be selected and played after the advertising message (s) is delivered. All these variations fall into the present inventive concept and are covered by the appended claims.

The advertising messages may be selected in a random manner.

Each advertising message may also be assigned a priority before they are loaded into the media player. The message may also be selected based upon its priority. The highest priority one is selected first. The priority for advertising messages may be adjusted after at least one advertising message is delivered.

FIG. 3B is a flow diagram of depicting steps for distributing media assets and advertising messages by the use of a portable media player and steps for encoding/decoding the media assets are shown. The process 320 starts with step 302 that a plurality of media assets is selected based upon a user's personal profile. In step 303, the selected media assets are encoded with a public key in an exemplary case. The encoding is based upon the public key/private key system. In one implementation, each media player 100 may be provided with a plurality of private keys embedded in the storage unit 108. In step 304, a plurality of advertising messages is selected based upon the user's personal profile. In step 306, the encoded media assets and the advertising messages are loaded up to the media player 100. The operations may be performed at a manufacturing site or at a point of sales before the device is shipped to the user. After receiving the media player, the user selects a pre-loaded media asset through the input unit 104 in step 308. The processor 102 of the media player 100 then selects at least one pre-loaded advertising message in step 3 10. The processor 102 controls an operation of streaming the selected advertising message(s) to the output unit 106 in step 312. After the completion of step 312, the processor 102 controls an operation of releasing the private key to decode the selected media asset in step 313. The selected media asset is delivered to the user in step 314.

According to one implementation of the present invention, the delivered media asset may be deleted. The original media asset in the encoded form is remained in the storage unit 108. According to another implementation, the delivered and decoded media asset may be re-encoded.

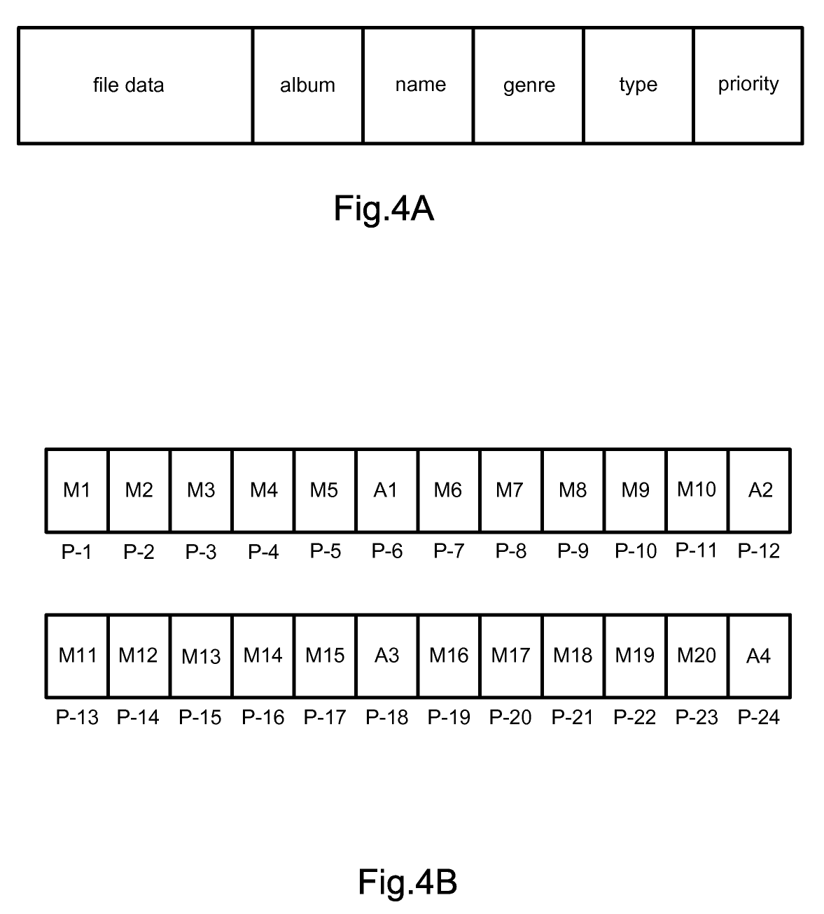

FIG. 4A is a schematic diagram of the media file format including file data in the form of MP3 track as an example for an audio asset (a song). The metadata fields for holding data indicate the name of the album the track is from, the name of the song, the genre of the song and the type of the track. The data format further includes two additional fields. One is used to indicate a file status of ‘visible’ or ‘hidden’. The media assets, that the user owns the right to play, have a status indicator of ‘visible’ that is visible to the user operating the media player in the sense of the conventional user interface. A pre-loaded media asset, that the user does not own the right to play, has a status indicator “hidden”, which is invisible to the user. The “hidden” assets may be organized into a separate play-list, which requires additional user interaction with the user interface to make the assets visible. Another added field is to indicate the priority of the stored media files. For media assets, that the user owns the right to play, they have a default priority “1” without difference. All other data files stored in the player also have a default priority “1”. The files with the priority “1” are typical with a visibility indicator as “visible”.

For the advertising messages, a similar data file structure maybe adopted. For all advertising messages, they have a status indicator as “hidden”. It should be noted the pre-loaded media assets and advertising messages should be ranked together for the priority ranking. When the storage capacity is required as a result of the user's operation of the device, lower priority data files will be removed automatically based upon their priorities.

For the advertising messages, the priority ranking may also be used to determine its priority to be delivered to the use. FIG. 4B is a schematic diagram illustrating a priority ranking system for pre-loaded media assets and advertising messages. In the figure, “Mx” stands for media assets and “Ax” stands for advertising messages. “P-x” stands for the priority of each file. When portion of the storage capacity is required as a results of the user's operation of the device, the lower priority files starting from P24 will be deleted until there is sufficient storage capacity for the operation or all 24 files are removed in this exemplary case.

For a more general case, for all hidden data files, they are assigned a priority starting from “2” to whatever number it takes to rank all hidden files sequentially.

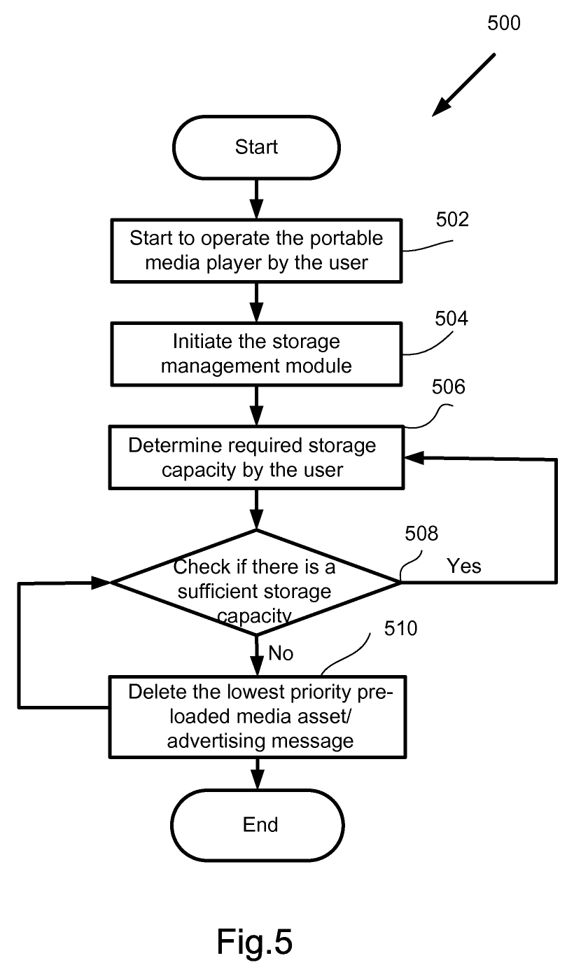

FIG. 5 is a flow diagram of depicting steps for managing the capacity of the storage unit 110 by the software module 112. Process 500 starts with step 502 that the user starts to operate the media player 100. The software module 112 is initiated immediately to manage the storage capacity in step 504. The required storage capacity for the user is determined on a real time base in step 506. In step 508, it is checked if there is a sufficient storage capacity for the user's operation. If the result is negative, the lowest priority data file (media asset or advertising message) is deleted in a repeated manner until a sufficient storage capacity is opened up for the user's operation or all pre-loaded data files are deleted.

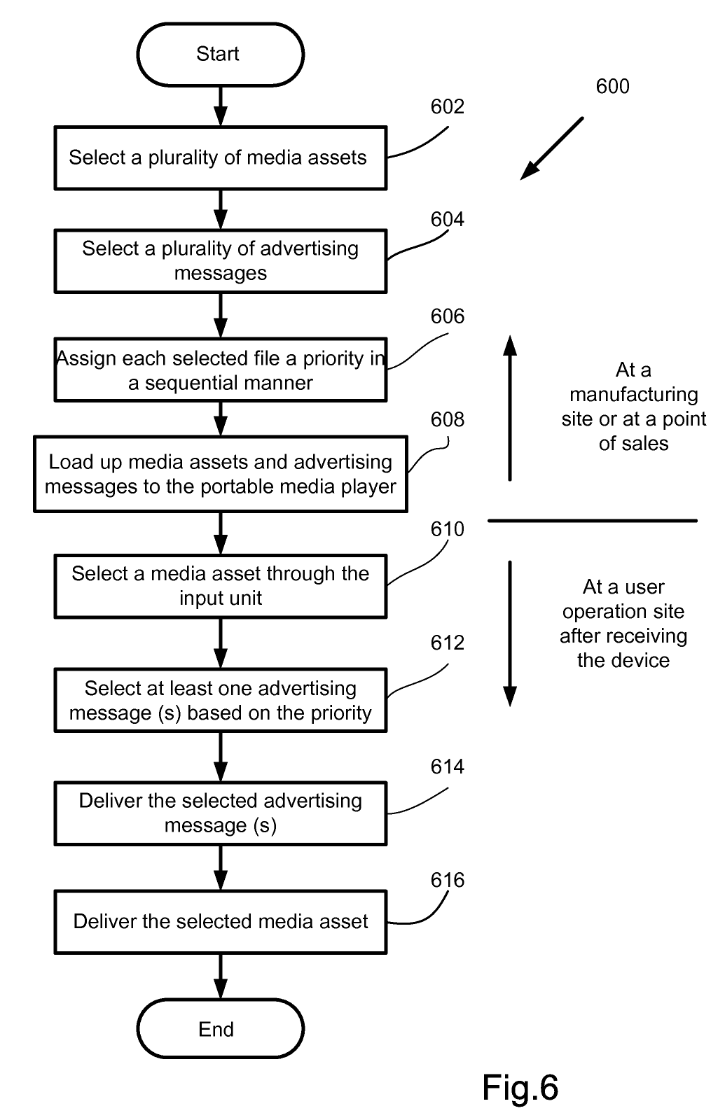

FIG. 6 is a flow diagram of depicting steps for distributing media assets and advertising messages by the use of a portable media player, wherein each media asset and each advertising message is assigned a priority. The process 600 starts with steps 602 and 604 that a plurality of media assets and a plurality of advertising messages are selected based upon the user's personal profile. Each data file (media asset or advertising message) is assigned a priority in step 606. In step 608, the media assets and advertising messages are loaded up to the media player 100. The operations may be performed at a manufacturing site or at a point of sales. After receiving the media player, the user selects a pre-loaded media asset through the input unit 104 in step 610. Following the step 610, the processor 102 of the media player 100 selects at least one pre-loaded advertising message in step 612. The processor 102 controls an operation of streaming the selected advertising message(s) to the output unit 106 in step 614. After the completion of step 614, the processor 102 controls an operation of delivering the selected media asset to the user in step 616.

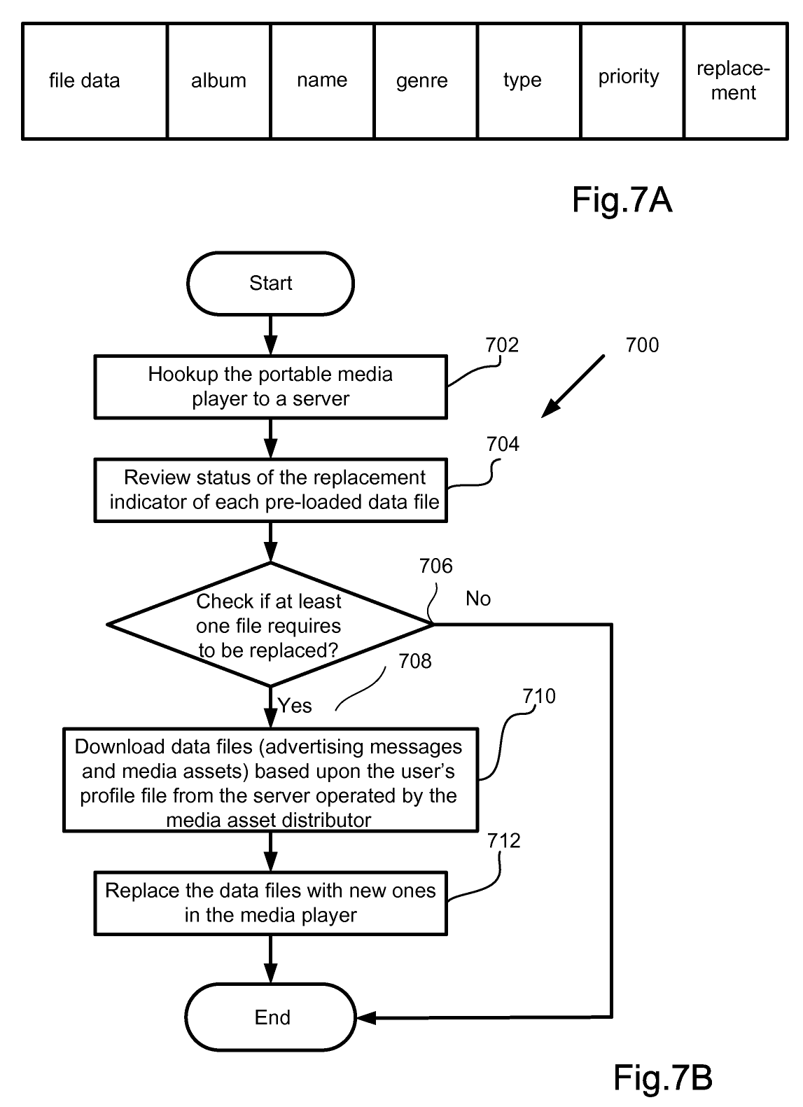

According to another aspect of the present invention as shown in FIG. 7A, the data file format may further include another added field. The indicator of the added field is for the replacement of the data file. All data file (media asset and advertising message) may have a default value of “No” for the “replacement” indicator. After playing of an advertising message or a media asset, the processor may change its indicator for the “replacement” to “Yes”. A value of “Yes” indicates that the file is ready to be replaced when the portable media player is connected to a server such as for example, a personal computer.

FIG. 7B is a flow diagram of depicting steps for replacing delivered advertising messages and/or delivered media assets. Process 700 starts with step 702 that the portable media player 100 is hooked up to a server such as for example, a personal computer. As it was pointed out previously that the portable media player has the capability to connect to a server for downloading media assets. In step 704, the status indicators for the “replacement” are reviewed for all the pre-loaded data files. If at least one file is ready for the replacement as checked in step 706, the new data file (s) will be downloaded from another server in the communication network, which is connected to an advertiser and/or a media asset distributor. The new advertising message (s) and media asset (s) are selected based upon the user's personal profile. The data files with the replacement status indicator as “Yes” are replaced in step 712.

While the invention has been disclosed with respect to a limited number of embodiments, numerous modifications and variations will be appreciated by those skilled in the art. A portable media player is used as an exemplary case to illustrate the invention. The inventive concept, however, can be extended to other portable electronic apparatus such as portable computing and communication devices, electronic books, mobile phones and portable game consoles. The media assets may include audio files, video files, text, games and multi-media files. The advertising messages may take various forms such as audio, video, multi-media, text and image. It is intended that all such variations and modifications fall with in the scope of the following claims:

1. A method of delivering advertising messages to a user of a portable media player comprising a processor, an input unit, an output unit and a storage unit with a storage capacity for storing data files, the method comprising the following steps:
a. selecting a plurality of media assets;
b. selecting a plurality of advertising messages;
c. loading up the media assets and the advertising messages to the storage unit of said portable media player;
d. selecting one media asset by the user through the input unit;
e. selecting at least one advertising message by the processor of the portable media player;
f. delivering the selected advertising message through the output unit of said portable media player; and
g. delivering the selected media asset through the output unit of said portable media player,
wherein the method is characterized by that the media assets and the advertising messages are selected based upon a personal profile file of the user, wherein the personal profile file including information indicating the user's interests in specific media asset groups and the user's interest in specific advertising message groups.

2. The method as recited in claim 1, wherein said steps a) to c) may be performed in a server at a manufacturing site or at a point of sales before the portable media player is shipped to the user.

3. The method as recited in claim 1, wherein said user's personal profile file may be sent to the server through a communication network or be established by the user at the point of sales.

4. The method as recited in claim 1, wherein the media assets are encrypted before they are loaded up into the portable media player.

5 The method as recited in claim 1, wherein the selected media asset is decrypted after the completion of the operation of delivering at least one selected advertising message.

6. The method as recited in claim 5, wherein the decrypted media asset is re-encrypted or the decrypted media asset is deleted.

7. The method as recited in claims 4-6, wherein said encryption/decryption is based upon public key/private key system.

8. The method as recited in claim 1, wherein said advertising message is selected, in said step e), in a random manner from the pre-loaded advertising messages.

9. The method as recited in claim 1, wherein said each advertising message is assigned a priority and said message is selected, in step e), based upon the assigned priority.

10. The method as recited in claim 9, wherein the priority of each advertising message is re-assigned after the selected advertising message is delivered.

11. The method as recited in claim 1, wherein the method further comprising a step that delivered advertising messages and/or delivered media assets are replaced when the portable media player is connected to a server.

12. A method of delivering advertising messages to a user of a portable media player comprising a processor, an input unit, an output unit and a storage unit with a storage capacity for storing data files, the method comprising the following steps:
a. selecting a plurality of media assets;
b. selecting a plurality of advertising messages;
c. assigning each selected data file (media asset and advertising message) with a priority in a sequential manner;
d. loading up the media assets and the advertising messages to a predetermined space with a predetermined storage capacity of the storage unit of said portable media player;
e. selecting one media asset by the user through the input unit;
f. selecting at least one advertising message by the processor of the portable media player based upon the assigned priority;
g. delivering said at least one selected advertising message through the output unit of said portable media player; and
h. delivering the selected media asset through the output unit of said portable media player,
wherein the method is characterized by that the predetermined storage capacity of said portable media player for storing pre-loaded media assets and advertising message is changeable and lower priority media assets and lower priority advertising messages are deleted when the capacity is required as a result of the user's operation of the media player.

13. The method as recited in claim 12, wherein data file structure for the media assets is with a file format including at least one field for numbering priority with regard to the use of the storage capacity of the portable media player.

14. The method as recited in claim 12, wherein data file structure for the advertising message is with a file format including at least one field for numbering priority with regard to the use of the storage capacity of the portable media player and to the sequence of the message is delivered to the user, wherein the priority of the message may be altered after the message is delivered.

15. The method as recited in claim 12, wherein said steps a) to d) may be performed in a server at a manufacturing site or at a point of sales before the portable media player is shipped to the user and the user's personal profile file may be sent to the server through a communication network or be established by the user at the point of sales.

16. The method as recited in claim 12, wherein said media assets are encrypted and decrypted based upon public key/private key system.

17. The method as recited in claim 12, wherein the media asset may be decrypted after at least one advertising message is delivered to the user and the delivered media asset may be re-encrypted or the delivered media asset may be deleted.

18. The method as recited in claim 12, wherein the priority of data files (media asset and advertising message) is adjustable by the processor of said portable media player.

19. A portable device of delivering media assets and advertising messages to a user, the device comprising:
a. a processor pertaining to control operation of the device;
b. an input unit;
c. an output unit;
d. a storage unit with a storage capacity; and
e. a software module,
wherein the software module comprising a means for managing the storage capacity, wherein at least a portion of the storage capacity is utilized to store a plurality of media assets and advertising messages and each asset or message is assigned a priority with regard to the use of the storage capacity, furthermore lower priority said media assets and advertising messages are deleted under the control of the software module when the capacity is required as a result of the user's operation of the portable media player.

20. The device as recited in claim 19, wherein said media assets and advertising messages are pre-loaded to the device in a manufacturing site or at a point of sales based upon a targeted user's personal interests in specific media asset groups and in specific advertising message groups.
